(19) United States
(12) Patent Application Publication
(10) Pub. No.: US 2013/0000355 A1
(43) Pub. Date: Jan. 3, 2013

(54) METHOD OF MANUFACTURING AN OPTICAL FILTER FOR AN ILLUMINANCE SENSOR

(76) Inventors: Sadao Oku, Chiba-shi (JP); Hiroyuki Fujita, Chiba-shi (JP); Koji Tsukagoshi, Chiba-shi (JP); Keiichiro Hayashi, Chiab-shi (JP); Hitoshi Kamamori, Chiba-shi (JP); Hiroshi Highuchi, Mie (JP)

(21) Appl. No.: 13/471,610

(22) Filed: May 15, 2012

(30) Foreign Application Priority Data
Jun. 30, 2011 (JP) 2011-145894

(51) Int. Cl. C03B 23/203; B24C 1/04; C03C 15/00; C03B 33/00; C03B 23/26

(52) U.S. Cl. 65/31; 65/56; 65/55; 65/45

(57) ABSTRACT

Provided is a method of manufacturing an optical filter for an illuminance sensor, which has spectral characteristics close to human luminosity characteristics, has high detection accuracy, and can be manufactured at low cost. The method includes the steps of: (a) punching a glass; (b) feeding a small piece of glass (7) having a filter effect; (c) softening the small piece of glass (7); and (d) abrading.

### BACKGROUND OF THE INVENTION

1. Field of the Invention

The present invention relates to a method of manufacturing an optical filter for a semiconductor illuminance sensor which uses a photodetection element such as a photodiode. This kind of semiconductor illuminance sensor is used for detecting the illuminance of a periphery thereof in fields of, for example, automatic lighting control and dimming for an illumination device, backlight control for a liquid crystal display device, backlight control for a keypad of a mobile phone, night-vision switching control for a security camera, and the like. Further, the semiconductor illuminance sensor is combined with a light emitting element to be used as a proximity sensor for detecting presence/absence of an object and measuring the distance of the object.

2. Description of the Related Art

The visible light for human beings lies between 380 to 780 nm, and of this range, a range between about 440 to 700 nm is the main sensitive wavelength range. However, depending on the light color (wavelength), the human eye senses high or low brightness even among the light having the same power. Relative luminosity characteristics represent relative brightness for each color, which is sensed high by the human eye, and have a peak in the vicinity of a green color having a wavelength of 500 to 600 nm.

An illuminance sensor for backlight control of a display device and the like are desired to have spectral sensitivity characteristics close to the human luminosity characteristics.

A photodiode is used in an illuminance sensor for detecting the visible light intensity, but the spectral sensitivity characteristics of the photodiode differ from the human luminosity characteristics. Therefore, in order to bring the spectral sensitivity characteristics close to the human luminosity characteristics, as described in Japanese Utility Model Application Laid-open No. Sho 61-82230 and Japanese Patent Application Laid-open No. 2007-48795, an optical filter or a multilayer reflective film is provided on the surface of the photodiode, or as described in Japanese Patent Application Laid-open Nos. 2006-148014 and 2009-238944, photodiodes having different sensitivity characteristics are used to perform correction based on results computed from a difference of currents flowing therethrough. Further, in order to enhance the correction accuracy, in Japanese Patent Application Laid-open Nos. 2007-48795 and 2007-536728, a window for regulating the incident light is provided.

However, in a method described in Japanese Patent Application Laid-open Nos. 2006-148014 and 2009-238944, which uses a plurality of photodiodes, there are problems of cost increase due to the use of the plurality of photodiodes, and insufficient correction accuracy.

In a method described in Japanese Utility Model Application Laid-open No. Sho 61-82230, which uses the optical filter, an interference filter formed of a dielectric multilayer is used as the optical filter, and hence the cost is higher. Further, the filter characteristics vary depending on the light incident angle, and hence the detection accuracy is still insufficient.

As a countermeasure, Japanese Patent Application Laid-open Nos. 2007-48795 and 2007-536728 propose a method of providing a window for regulating the incident light, but increase in cost for forming the window cannot be avoided.

### SUMMARY OF THE INVENTION

The present invention has been made to solve the problems described above, and has an object to provide a method of manufacturing an optical filter for an illuminance sensor, which has spectral characteristics close to human luminosity characteristics, has high detection accuracy, and can be manufactured at low cost.

In order to achieve the above-mentioned object, a method of manufacturing an optical filter for an illuminance sensor according to an exemplary embodiment of the present invention includes: a first step of opening a hole in a glass plate; a second step of arranging, in the hole of the glass plate, a small piece of glass having an optical filter effect and having a glass softening point lower than a glass softening point of the glass base; a third step of softening the small piece of glass under high temperature; and a fourth step of abrading both surfaces of the glass base to planarize the glass base.

Further, the hole may be a through hole.

Further, the first step may be carried out by molding.

Alternatively, the first step may be carried out by sandblasting.

Alternatively, the first step may be carried out by glass etching.

Further, the small piece of glass may have a bead shape.

Further, the third step of softening the small piece of glass under high temperature may include sandwiching the glass base with plate members and applying a pressure to the glass base.

Further, after the third step of softening the small piece of glass under high temperature, a step of sandwiching the glass base with flat molds and applying a pressure to the glass base under high temperature may be added.

Further, the hole of the glass base may have a frustum shape with a step.

Alternatively, the hole of the glass base may have a hand-drum shape in which a diameter is small at a center portion thereof.

Further, the glass plate may be a glass plate having light blocking characteristics.

Further, the glass plate may be a black glass plate.

Further, the black glass plate may contain 3 to 20% of a black pigment.

The method of manufacturing an optical filter for an illuminance sensor according to the exemplary embodiment of the present invention includes the steps of punching the glass, arranging the small piece of glass, softening the small piece of glass, and abrading. All of the manufacturing steps are simple steps, and hence the manufacturing cost can be greatly reduced as compared to a conventional method. Further, through selection of glass having a filter effect close to color correction characteristics as the small piece of glass, excellent correction characteristics can be obtained. Thus, unlike the case of using the interference filter, filter characteristics do not vary depending on the light incident angle, and further, a window for regulating the incident light is provided, and hence a cost-effective illuminance sensor having very high accuracy can be provided.

### BRIEF DESCRIPTION OF THE DRAWINGS

In the accompanying drawings:

FIGS. 1A and 1B are a sectional view and a top view, respectively, schematically illustrating a structure of an illuminance sensor which uses an optical filter formed by a manufacturing method according to the present invention;

FIGS. 2A to 2E are sectional views schematically illustrating manufacturing steps of an optical filter for an illuminance sensor of the present invention;

FIGS. 3A to 3C are sectional views schematically illustrating manufacturing steps of a part of the illuminance sensor which uses the optical filter of the present invention;

FIGS. 4A to 4E are sectional views schematically illustrating manufacturing steps of an optical filter for an illuminance sensor of the present invention;

FIGS. 5A to 5C are sectional views schematically illustrating manufacturing steps of an optical filter for an illuminance sensor of the present invention;

FIG. 6 is a sectional view schematically illustrating a failure example of the optical filter for an illuminance sensor of the present invention;

FIG. 7 is a sectional view schematically illustrating another failure example of the optical filter for an illuminance sensor of the present invention;

FIGS. 8A to 8C are sectional views schematically illustrating manufacturing steps of an optical filter for an illuminance sensor of the present invention;

FIGS. 9A to 9D are sectional views schematically illustrating manufacturing steps of an optical filter for an illuminance sensor of the present invention;

FIGS. 10A to 10D are sectional views schematically illustrating manufacturing steps of an optical filter for an illuminance sensor of the present invention;

FIGS. 11A to 11D are sectional views schematically illustrating manufacturing steps of an optical filter for an illuminance sensor of the present invention; and

FIG. 12 is a sectional view schematically illustrating a structure of an illuminance sensor which uses the optical filter formed by the manufacturing method according to the present invention.

### DETAILED DESCRIPTION OF THE PREFERRED EMBODIMENTS

A method of manufacturing an optical filter for an illuminance sensor according to the present invention includes opening a hole in a glass plate at a predetermined position and size in conformity to a sensor element, and then heating and embedding a small piece of glass having an optical filter effect, thereby manufacturing the optical filter. The used small piece of glass having the optical filter effect is selected depending on the characteristics of the sensor element and the intended use of the illuminance sensor. Further, in a step of abrading a glass base having the small piece of glass embedded therein, the thickness of the glass base is controlled, and thus an optical filter having a desired optical filter effect can be manufactured.

Specifically, the method of manufacturing an optical filter for an illuminance sensor includes a punching step, an arranging step, an embedding step, and an abrading step. In the punching step, a mold having a protrusion on a surface thereof is heated and pressed against the glass plate at a temperature equal to or higher than a softening point of the glass, to thereby form a hole. Alternatively, the hole is formed by sandblasting or glass etching. In the arranging step, the small piece of glass having the optical filter effect is arranged in the hole of the glass base. In the embedding step, the small piece of glass is heated to a temperature between a softening point of the small piece of glass and the softening point of the glass base, and the small piece of glass is softened to be embedded in the hole. In the abrading step, the projected small piece of glass after the softening is abraded and planarized. In a case where the hole is a bottomed hole, a rear surface of the glass base is abraded to expose the small piece of glass. Further, the thickness of the glass base is adjusted to have a predetermined value.

Hereinafter, a method of manufacturing an optical filter for an illuminance sensor of the present invention is described in detail with reference to the drawings.

### First Embodiment

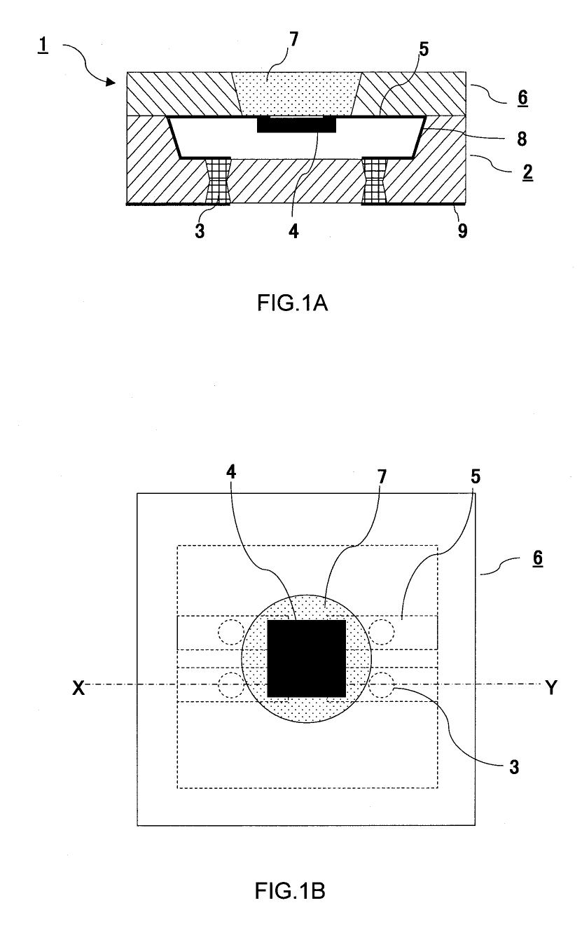

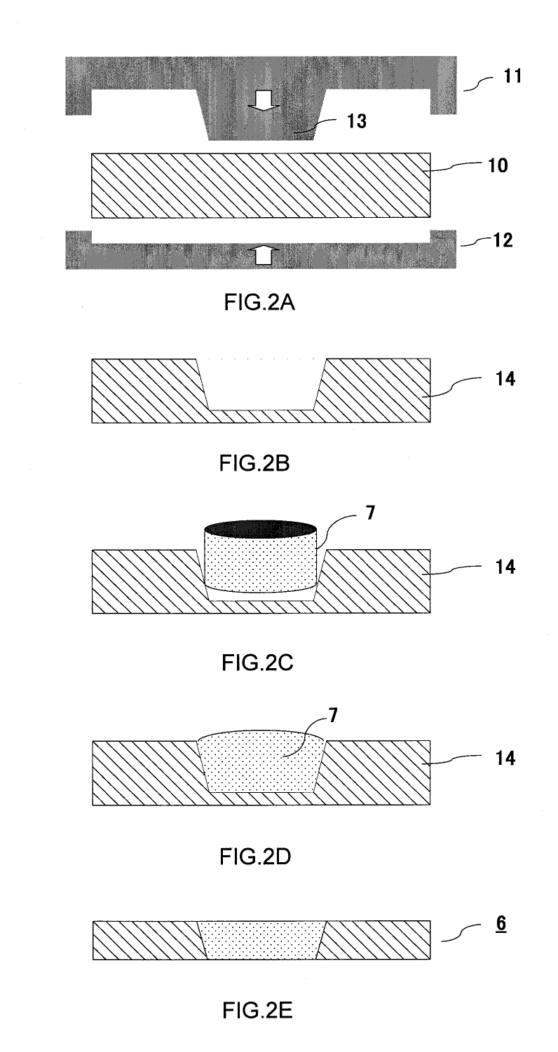

FIGS. 2A to 2E are sectional views schematically illustrating manufacturing steps of an optical filter of a first embodiment of the present invention. Further, FIGS. 1A and 1B are a sectional view and a plan view, respectively, schematically illustrating a structure of an illuminance sensor which uses the optical filter manufactured in this embodiment.

<Punching Step>

FIG. 2A is a sectional view illustrating the punching step. A glass plate 10 is placed between an upper mold 11 having a protrusion 13 on a surface thereof, and a lower mold 12 having a flat surface. Next, the upper mold 11, the lower mold 12, and the glass plate 10 are heated to soften the glass plate 10. When soda glass is used as the glass plate 10, the glass plate 10 is heated to about 700° C. to 900° C. Then, the upper mold 11 and the lower mold 12 are pressed in directions of the arrows. With this, as illustrated in FIG. 2B, a glass base 14 having a hole at a center thereof is formed. The hole is desired to have a frustum shape in view of moldability and easiness in feeding performance in the subsequent arranging step.

As another method, there may be employed a method of blasting an abrasive such as alumina to the glass plate 10 to open a hole, that is, so-called sandblasting. Also in this case, the glass base 14 having a hole can be formed.

Alternatively, a resist may be printed onto the surface of the glass plate 10 except for a hole portion, a resist may also be applied over the entire glass rear surface, then the glass plate 10 may be immersed into a glass etchant such as hydrofluoric acid to open a hole, and finally the resist may be removed. Even in this case, the glass base 14 having a hole can be similarly formed.

<Arranging Step>

FIG. 2C illustrates a state in which a small piece of glass 7 having the optical filter effect is arranged in the hole of the glass base 14.

It is ideal that the optical filter effect necessary for the illuminance sensor conforms to a color correction curve, but in this case, the filter transmittance decreases. In a case where the sensitivity is valued, a filter for blocking only the infrared ray is used. In the latter case, phosphate glass is used, and in the former case, glass obtained by adding metal oxide such as CuO to phosphate glass is used. Phosphate glass tends to have weak moisture resistance, and hence in a case where weather resistance is demanded, adjustment may be made by adding an inorganic pigment to silicate glass. In all of the above-mentioned cases, the glass composition is adjusted so that the glass material for the small piece of glass 7 has a lower softening point than that for the glass base 14.

The glass having the optical filter effect is obtained by forming a glass rod having a diameter corresponding to the hole of the glass base 14, and cutting the glass rod to have a volume corresponding to the embedding amount. Thus, the columnar small piece of glass 7 is obtained.

Note that, a rectangular parallelepiped or cubic small piece of glass 7 is also usable, and in this case, glass in an ingot state may be sliced by a slicer or a wire cutting machine, and then may be cut to have a predetermined volume.

The small piece of glass 7 can be easily fed into the hole of the glass base by spreading the small piece of glass 7 on the glass base 14 and vibrating the glass base 14.

<Embedding Step>

FIG. 2D is a sectional view illustrating a state in which the small piece of glass 7 is embedded into the glass base.

The glass base 14 and the small piece of glass 7, which are obtained after finishing the arranging step illustrated in FIG. 2C, are heated to a temperature which is lower than the softening point of the glass base 14 and higher than the softening point of the small piece of glass 7. The phosphate glass has the softening point of about 500° C. to 650° C., and hence when soda glass is used for the glass plate 10, the glass base 14 and the small piece of glass 7 are heated to 550° C. to 700° C. Thus, only the small piece of glass 7 is softened, and as illustrated in FIG. 2D, the hole is filled.

When a coefficient of thermal expansion of the glass base 14 is larger than that of the small piece of glass 7, cracks are liable to be generated in the small piece of glass, and when the coefficient of thermal expansion of the small piece of glass 7 is larger than that of the glass base 14, the small piece of glass may be easily slipped out. Therefore, the difference therebetween is desired to be within 30×10⁻⁷/° C.

<Abrading Step>

The glass base 14 and the small piece of glass 7, which are obtained after finishing the softening and embedding of the small piece of glass 7, are abraded so that a front surface thereof is planarized, the small piece of glass 7 is exposed on a rear surface thereof, and the small piece of glass 7 has a predetermined thickness. Thus, an optical filter substrate 6 of FIG. 2E is completed.

FIGS. 1A and 1B are a sectional view and a plan view, respectively, schematically illustrating a structure of an illuminance sensor 1 which uses the optical filter of the first embodiment. The optical filter substrate 6 is provided with a mounting electrode 5 for mounting an illuminance sensor element 4. The illuminance sensor element 4 is disposed and mounted under the small piece of glass having the optical filter effect. Other cavity substrate 2 includes a wiring electrode 8 and a through-electrode 3, and the sensor element 4 is connected via the mounting electrode 5, the wiring electrode 8, and the through-electrode 3 to an external electrode terminal 9. When the cavity substrate 2 is also made of a glass material, the whole package is made of a glass material, and hence it is possible to provide an illuminance sensor device having an extremely high durability.

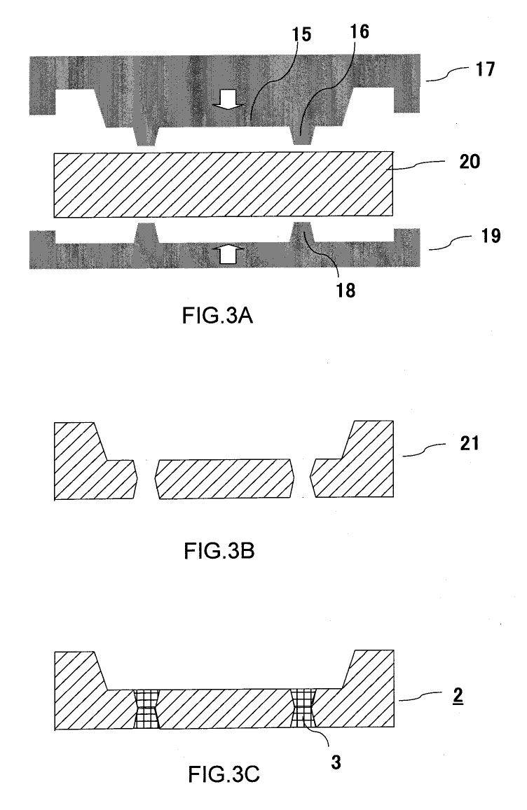

For reference, FIGS. 3A to 3C are sectional views schematically illustrating manufacturing steps of the cavity substrate 2 that are disclosed in Japanese Patent Application No. 2008-249484 by the inventors of the present invention. As illustrated in FIG. 3A, a glass plate 20 is placed between an upper mold 17 having a protrusion 15 for the cavity and a protrusion 16 for the through-electrode on a surface thereof, and a lower mold 19 having a protrusion 18 for the through-electrode. Next, the upper mold 17, the lower mold 19, and the glass plate 20 are heated to soften the glass plate 20. Then, the upper mold 17 and the lower mold 19 are pressed in directions of the arrows. With this, as illustrated in FIG. 3B, a cavity substrate 21 having a cavity and a through hole is obtained. As illustrated in FIG. 3C, the through hole is filled with a conductive material such as Ag paste to serve as a through-electrode 3. Further, the wiring electrode and the external electrode terminal are formed. In this manner, the cavity substrate 2 illustrated in FIGS. 1A and 1B can be easily obtained, and by being combined with the optical filter of the present invention, a package having high durability can be provided at low cost.

### Second Embodiment

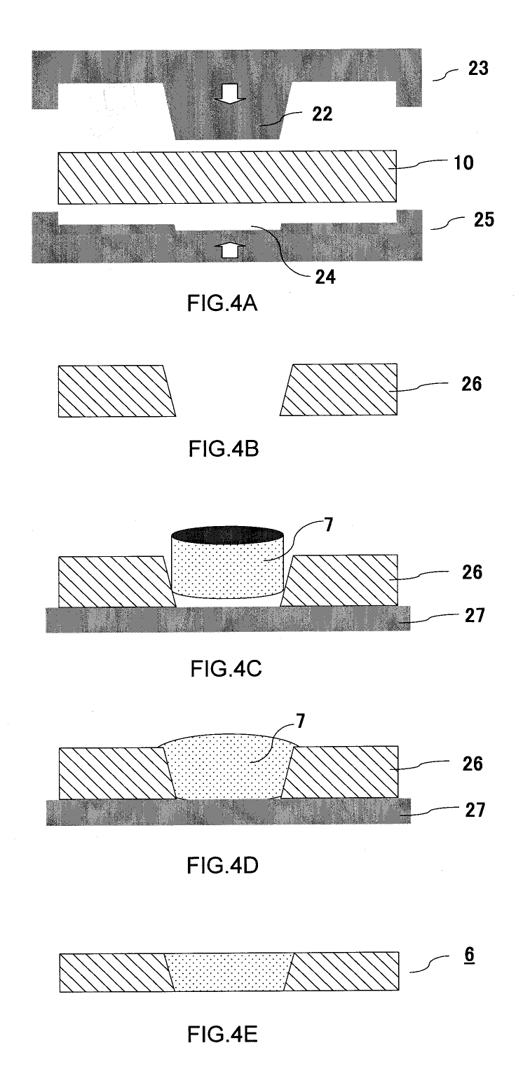

FIGS. 4A to 4E are sectional views schematically illustrating manufacturing steps of a second embodiment of the present invention.

<Punching Step>

FIG. 4A is a sectional view illustrating the punching step. The glass plate 10 is placed between an upper mold 23 having a protrusion 22 on a surface thereof, and a lower mold 25 having a recess 24 on a surface thereof. Next, the upper mold 23, the lower mold 25, and the glass plate 10 are heated to soften the glass plate 10. Then, the upper mold 23 and the lower mold 25 are pressed in directions of the arrows. With this, as illustrated in FIG. 4B, a glass base 26 having a through hole at a center thereof is formed.

<Arranging Step>

FIG. 4C illustrates a state in which the small piece of glass 7 having the optical filter effect is arranged in the hole of the glass base 26. The glass base 26 is placed on a plate member 27, and similarly to the first embodiment, the small piece of glass 7 is spread on the glass base 26 and the glass base 26 is vibrated. Thus, the small piece of glass 7 can be easily fed into the hole of the glass base. When the shape of the hole and the size of the small piece of glass are adjusted, the small piece of glass can be caught by the hole to not fall, and hence the plate member 27 is unnecessary.

<Embedding Step>

The glass base 26 and the small piece of glass 7, which are obtained after finishing the arranging step illustrated in FIG. 4C, are heated to a temperature which is lower than the softening point of the glass base 26 and higher than the softening point of the small piece of glass 7. As a result, as illustrated in FIG. 4D, the small piece of glass 7 can be embedded into the hole.

<Abrading Step>

Next, abrading is performed to planarize the surface and adjust the thickness. Thus, the optical filter substrate 6 of FIG. 4E can be obtained.

In this embodiment, the small piece of glass is also exposed at the rear surface in the embedding step, and hence as compared to the first embodiment, the abrading amount in the abrading step can be reduced, and the abrading cost can be reduced.

### Third Embodiment

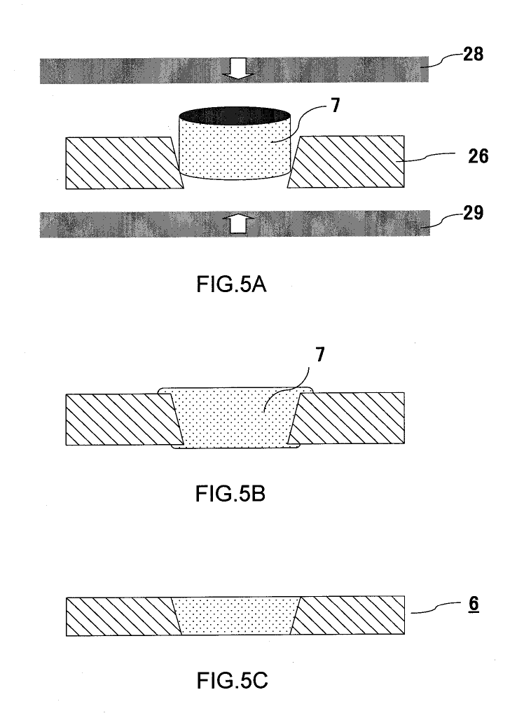

FIGS. 5A to 5C are sectional views schematically illustrating manufacturing steps of a third embodiment of the present invention. The punching step and the arranging step are the same as those of the second embodiment, and hence description thereof is omitted. The embedding step and the subsequent step are described below.

<Embedding Step>

FIG. 5A illustrates the embedding step of this embodiment. The glass base 26 having the small piece of glass 7 arranged therein is placed between an upper mold 28 and a lower mold 29, which have a flat surface. Next, the upper mold 28, the lower mold 29, the glass base 26, and the small piece of glass 7 are heated to a temperature which is lower than the softening point of the glass base 26 and higher than the softening point of the small piece of glass 7. Then, the upper mold 28 and the lower mold 29 are pressed in directions of the arrows. As a result, as illustrated in FIG. 5B, the softened small piece of glass 7 is completely embedded into the through hole by the pressure, and the surface thereof is formed flat.

<Planarization Step>

Next, abrading is performed to planarize the surface and adjust the thickness. Thus, the optical filter substrate 6 of FIG. 5C can be obtained.

In this embodiment, the projection of the small piece of glass after the embedding step is small and flat, and hence the glass can be prevented from being broken in the abrading step. Further, as compared to the first and second embodiments, the rate of failure during the abrading can be greatly reduced.

### Fourth Embodiment

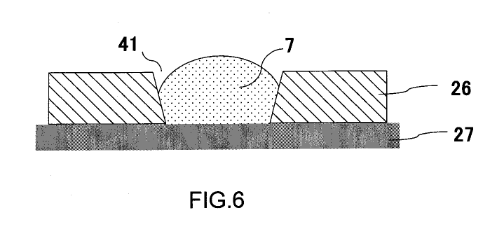

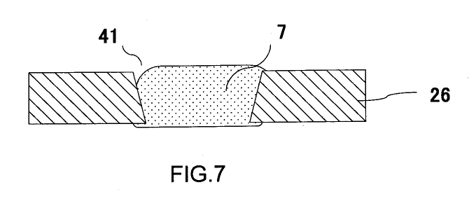

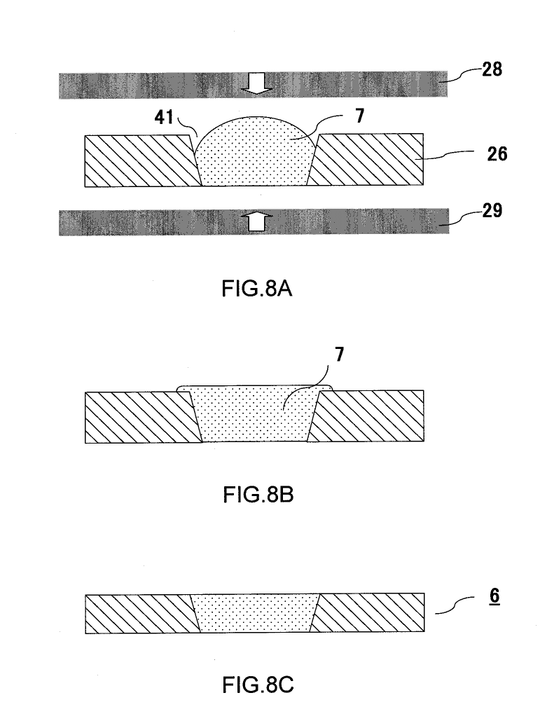

FIGS. 8A to 8C are sectional views schematically illustrating manufacturing steps of a fourth embodiment of the present invention. The punching step and the arranging step are the same as those of the second embodiment, and hence description thereof is omitted. The embedding step and the abrading step are described. Further, FIGS. 6 and 7 are schematic sectional views illustrating failure examples of the optical filter, for describing the effect of this embodiment.

<Embedding Step>

FIG. 6 is a sectional view of an example of a state after the embedding step of the second embodiment. The columnar small piece of glass 7 is softened to be round and is embedded into the glass base 26. When the softened small piece of glass 7 has a high viscosity, a gap 41 may be formed in the hole, and the gap may remain even after the abrading in some cases.

FIG. 7 is a sectional view of another example of a state after the embedding step of the third embodiment. When the columnar small piece of glass 7 is arranged in a tilted manner in the arranging step and the softened small piece of glass 7 has a high viscosity, the tilt may not be corrected when pressing is performed by the flat molds in the embedding step, and the gap 41 may be formed on only one side in some cases. When the gap remains even after the abrading, reduction in yield may be caused.

In order to eliminate the above-mentioned defects, the embedding step of this embodiment is carried out by performing, after the embedding step of the second embodiment (first embedding step), the embedding step of the third embodiment (second embedding step). FIG. 8A is a sectional view illustrating the second embedding step. Even when the columnar small piece of glass 7 is arranged in a tilted manner in the arranging step, at the time of softening the small piece of glass 7 obtained after finishing the first embedding step, the small piece of glass 7 becomes round at a center of the hole due to the surface tension. The glass base 26 and the small piece of glass 7 are placed between the upper mold 28 and the lower mold 29, which have flat surfaces, and are heated to a temperature which is lower than the softening point of the glass base 26 and higher than the softening point of the small piece of glass 7. Then, the upper mold 28 and the lower mold 29 are pressed in directions of the arrows. As a result, as illustrated in FIG. 8B, the softened small piece of glass 7 is embedded into the through hole by the pressure without a gap, and the surface thereof is formed flat.

<Abrading Step>

Next, abrading is performed to planarize the surface and adjust the thickness. Thus, the optical filter substrate 6 of FIG. 8C is obtained.

When the first and second embedding steps are performed as described above, regardless of the arrangement fluctuations in the arranging step or the viscosity of the softened small piece of glass, the small piece of glass can be embedded into the through hole without a gap, and hence stable production is possible.

### Fifth Embodiment

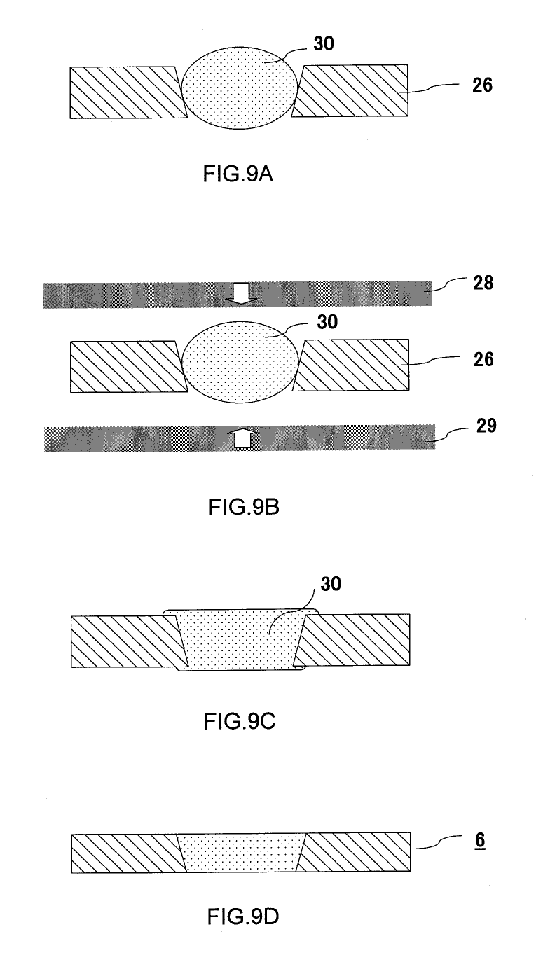

FIGS. 9A to 9D are sectional views schematically illustrating manufacturing steps of a fifth embodiment of the present invention. The punching step is the same as that of the second embodiment, and hence description thereof is omitted. The arranging step, the embedding step, and the abrading step are described.

<Arranging Step>

FIG. 9A illustrates a state in which a small piece of glass 30, which has an optical filter effect and is formed into a bead shape, is arranged in the hole of the glass base 26. When the small piece of glass 30 is formed into a bead shape, the small piece of glass 30 can be easily fed into the hole of the glass base 26, and hence the arranging step is facilitated.

Note that, the bead shape may be a sphere or an ellipse, but a sphere can provide better performance in feeding into the hole.

<Embedding Step>

FIG. 9B illustrates the embedding step of this embodiment. The glass base 26 having the bead-shaped small piece of glass 30 arranged therein is placed between the upper mold 28 and the lower mold 29, which have flat surfaces. Next, the upper mold 28, the lower mold 29, the glass base 26, and the small piece of glass 30 are heated to a temperature lower than the softening point of the glass base 26 and higher than the softening point of the small piece of glass 30. Then, the upper mold 28 and the lower mold 29 are pressed in directions of the arrows. As a result, as illustrated in FIG. 9C, the softened small piece of glass 30 is completely embedded into the through hole by the pressure, and the surface thereof is formed flat.

<Abrading Step>

Next, abrading is performed to planarize the surface and adjust the thickness. Thus, the optical filter substrate 6 of FIG. 9D is obtained.

When the bead-shaped small piece of glass 30 is used, unlike the case where a columnar or rectangular parallelepiped small piece of glass is used, the small piece of glass 30 is not arranged in a tilted manner in the arranging step. Therefore, the first embedding step of the fourth step is unnecessary, and stable production is possible with reduced steps.

### Sixth Embodiment

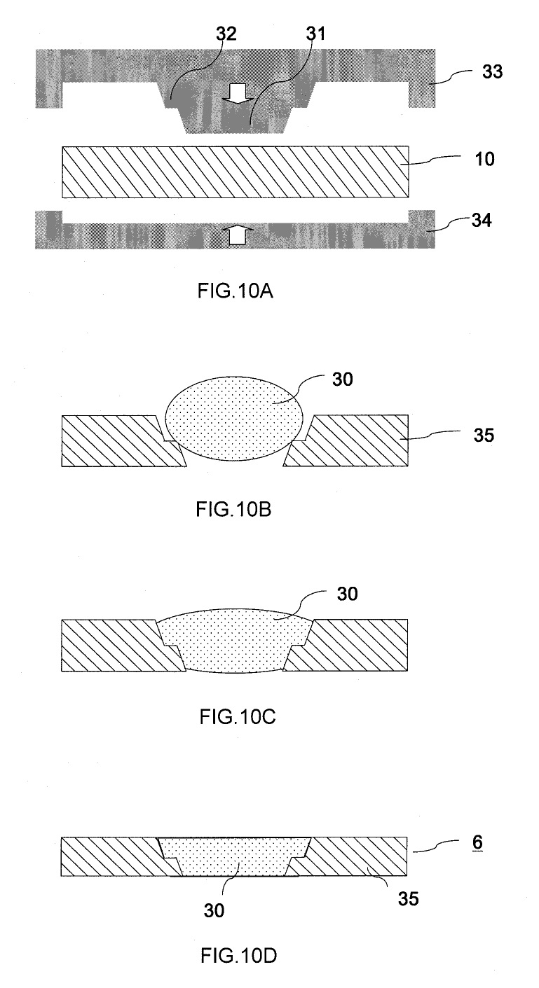

FIGS. 10A to 10D are sectional views schematically illustrating manufacturing steps of a sixth embodiment of the present invention.

<Punching Step>

FIG. 10A is a sectional view illustrating the punching step. The glass plate 10 is placed between an upper mold 33 having protrusions 31 and 32 on a surface thereof, and a lower mold 34 having a flat surface. Next, the upper mold 33, the lower mold 34, and the glass plate 10 are heated to soften the glass plate 10. Then, the upper mold 33 and the lower mold 34 are pressed in directions of the arrows. With this, as illustrated in FIG. 10B, a glass base 35 having a frustum through hole with a step at a center thereof is formed.

<Arranging Step>

FIG. 10B illustrates a state in which a small piece of glass 30, which has an optical filter effect and is formed into a bead shape, is arranged in the hole of the glass base 35. The hole is the frustum through hole with a step at a center thereof, and hence the small piece of glass 30 is supported by the step. Therefore, the plate member 27 illustrated in FIG. 4C, which is used in the arranging step of the second embodiment, is unnecessary, and the number of steps in the arranging step can be reduced.

<Embedding Step>

FIG. 10C is a sectional view illustrating a state after the embedding step of this embodiment. The small piece of glass 30 softened in the embedding step is supported by the step of the hole, and hence similarly to the case of the arranging step, the plate member need not be arranged under the glass base, and the number of steps in the embedding step can be reduced.

<Abrading Step>

Next, abrading is performed to planarize the surface and adjust the thickness. Thus, the optical filter substrate 6 of FIG. 10D is obtained.

In this embodiment, in addition to the effect that the number of steps can be reduced as described above, the contact area between the small piece of glass 30 and the glass base 35 increases, and hence reliability and durability in a temperature shock test and the like are enhanced.

### Seventh Embodiment

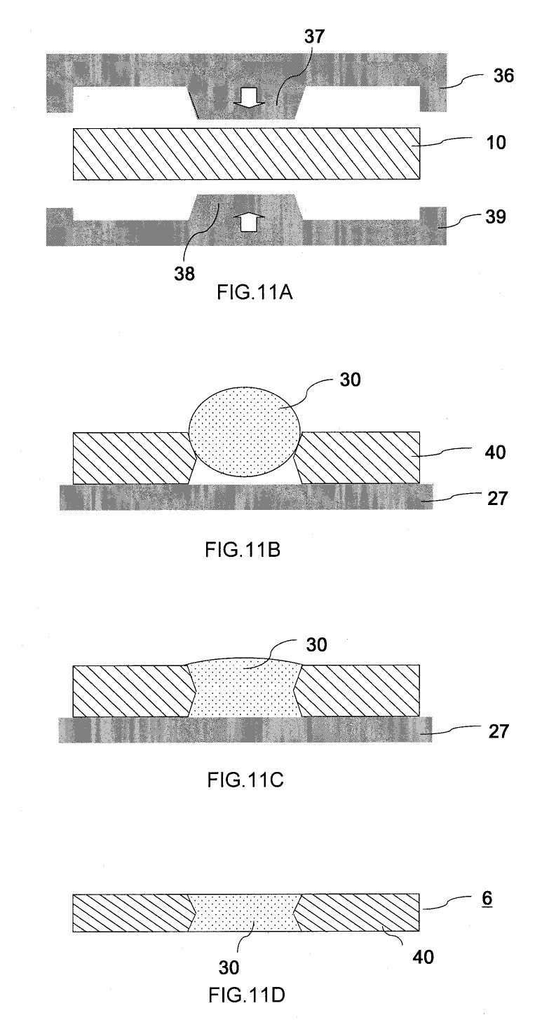

FIGS. 11A to 11D are sectional views schematically illustrating manufacturing steps of a seventh embodiment of the present invention.

<Punching Step>

FIG. 11A is a sectional view illustrating the punching step. The glass plate 10 is placed between an upper mold 36 having a protrusion 37 on a surface thereof, and a lower mold 39 having a protrusion 38 on a surface thereof. Next, the upper mold 36, the lower mold 39, and the glass plate 10 are heated to soften the glass plate 10. Then, the upper mold 36 and the lower mold 39 are pressed in directions of the arrows. With this, as illustrated in FIG. 11B, a glass base 40 having a through hole having a hand-drum shape in which a diameter is small at a center portion thereof is formed.

<Arranging Step>

FIG. 11B illustrates a state in which a small piece of glass 30, which has an optical filter effect and is formed into a bead shape, is arranged in the hole of the glass base 40. The glass base 40 is placed on the plate member 27, and similarly to the first embodiment, the small piece of glass 30 is spread on the glass base 40 and the glass base 40 is vibrated. Thus, the small piece of glass 30 can be easily fed into the hole of the glass base.

<Embedding Step>

FIG. 11C is a sectional view illustrating a state after the embedding step of this embodiment.

<Abrading Step>

Next, abrading is performed to planarize the surface and adjust the thickness. Thus, the optical filter substrate 6 of FIG. 11D is obtained. In this embodiment, the through hole having a hand-drum shape in which a diameter is small at a center portion thereof is provided. Therefore, the small piece of glass is not slipped out from the hole during the abrading, and the rate of failure during the abrading can be reduced.

Further, in this embodiment, similarly to the sixth embodiment, the contact area between the small piece of glass 30 and the glass base 40 increases, and hence reliability and durability in a temperature shock test and the like are enhanced.

### Eighth Embodiment

In the first embodiment, glass having light blocking characteristics is used for the glass plate 10. The light blocking characteristics of the glass can be obtained by dispersing, in glass, a material having a refractive index different from that of the glass, such as Al₂O₃, TiO₂, and ZrO₂. For example, when 20% or more of ZrO₂ is added to soda glass, glass having a transmittance of 5% or less at a thickness of 0.5 mm is obtained.

With use of the glass having the light blocking characteristics, incident light entering into the illuminance sensor element 4 illustrated in FIGS. 1A and 1B is only incident light from the small piece of glass having the filter effect of the optical filter substrate, and hence the accuracy as the illuminance sensor can be enhanced. Further, the glass plate 10 is only required to be changed to glass having light blocking characteristics, and hence the characteristics can be improved while maintaining the low cost, which is the feature of the present invention, without increasing the number of steps.

### Ninth Embodiment

As the glass having the light blocking characteristics of the eighth embodiment, black glass is used. The black glass is obtained by adding a pigment such as iron oxide to glass. For example, when 3% of black pigment mainly containing iron oxide is added to soda glass, glass having a transmittance of 5% or less at a thickness of 0.5 mm is obtained. Thus, with a lower concentration additive amount than the case of Al₂O₃ or TiO₂, the necessary light blocking rate can be obtained. Further, when 20% of the black pigment is added, a transmittance of 5% or less can be obtained even when the thickness of the optical filter substrate 6 is 0.2 mm, and hence a thin illuminance sensor can be provided.

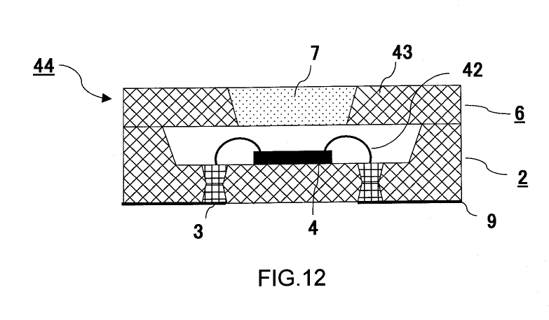

FIG. 12 is a sectional view schematically illustrating a structure of an illuminance sensor 44 which uses the optical filter of this embodiment. The optical filter substrate 6 includes black glass 43 and the small piece of glass 7 having the filter effect. The other cavity substrate 2 includes the through-electrode 3, and the sensor element 4 is die-bonded to the cavity substrate 2. The sensor element 4 is connected to the through-electrode 3 via a wire 42, and is connected to the external electrode terminal 9 through the through-electrode 3. When the cavity substrate 2 is also made of a black glass material, light entering the sensor element 4 is only light that has passed through the small piece of glass 7, and hence a high-performance illuminance sensor can be provided. In particular, in the illuminance sensor 1 illustrated in FIGS. 1A and 1B, the active area of the sensor element 4 is brought into contact with the small piece of glass 7, and hence the effect of the black glass is small. However, the illuminance sensor 44 has the sensor element 4 set apart from the optical filter substrate 6, and hence the light blocking effect of the black glass is extremely large.

In the above, by means of the first to ninth embodiments, the method of manufacturing a single optical filter substrate 6 has been described, but multiple optical filter substrates 6 can be formed at once. Further, the hole into which the small piece of glass is embedded is described to have a circular shape, but depending on the sensor element, the package specification, and the intended use, the hole may have a multangular shape such as a triangular shape, a square shape, and a hexagonal shape, or a shape having a circular-arc or hyperbolic inclination surface.

A reliable optical filter for an illuminance sensor, which has spectral characteristics close to human luminosity characteristics, can be easily manufactured at low cost, and hence the present invention can contribute to supply of an illuminance sensor usable for many uses.

What is claimed is:

1. A method of manufacturing an optical filter for an illuminance sensor, comprising:
opening a hole in a glass plate;
arranging, in the hole of the glass plate, a small piece of glass having an optical filter effect and having a glass softening point lower than a glass softening point of the glass plate;
softening the small piece of glass under high temperature to fill the hole; and
abrading the glass plate.

2. A method of manufacturing an optical filter for an illuminance sensor according to claim 1, wherein the hole to be formed in the glass plate comprises a through hole.

3. A method of manufacturing an optical filter for an illuminance sensor according to claim 2, wherein the opening of the hole in the glass plate is carried out by molding.

4. A method of manufacturing an optical filter for an illuminance sensor according to claim 2, wherein the opening of the hole in the glass plate is carried out by sandblasting.

5. A method of manufacturing an optical filter for an illuminance sensor according to claim 2, wherein the opening of the hole in the glass plate is carried out by glass etching.

6. A method of manufacturing an optical filter for an illuminance sensor according to claim 1, wherein the small piece of glass has a bead shape.

7. A method of manufacturing an optical filter for an illuminance sensor according to claim 1, wherein the softening of the small piece of glass under high temperature to fill the hole comprises sandwiching the glass plate with flat molds and applying a pressure to the glass plate.

8. A method of manufacturing an optical filter for an illuminance sensor according to claim 1, further comprising sandwiching the glass plate with flat molds and applying a pressure to the glass plate under high temperature, wherein the sandwiching succeeds the softening of the small piece of glass under high temperature to fill the hole.

9. A method of manufacturing an optical filter for an illuminance sensor according to claim 1, wherein the hole of the glass plate has a frustum shape with a step.

10. A method of manufacturing an optical filter for an illuminance sensor according to claim 1, wherein the hole of the glass plate has a hand-drum shape in which a diameter is small at a center portion thereof.

11. A method of manufacturing an optical filter for an illuminance sensor according to claim 1, wherein the glass plate has light blocking characteristics.

12. A method of manufacturing an optical filter for an illuminance sensor according to claim 11, wherein the glass plate comprises a black glass plate.

13. A method of manufacturing an optical filter for an illuminance sensor according to claim 12, wherein the black glass plate contains 3 to 20% of a black pigment.

14. A method of manufacturing an optical filter for an illuminance sensor according to claim 1, wherein the opening of the hole in the glass plate is carried out by molding.

15. A method of manufacturing an optical filter for an illuminance sensor according to claim 1, wherein the opening of the hole in the glass plate is carried out by sandblasting.

16. A method of manufacturing an optical filter for an illuminance sensor according to claim 1, wherein the opening of the hole in the glass plate is carried out by glass etching.
